(19) United States
(12) Patent Application Publication
(10) Pub. No.: US 2016/0089601 A1
(43) Pub. Date: Mar. 31, 2016

(54) PIEZOELECTRIC VIDEO GAME CONTROLLER

(71) Applicant: Justin Terry, Brigham City, UT (US)

(72) Inventor: Justin Terry, Brigham City, UT (US)

(21) Appl. No.: 14/497,048

(22) Filed: Sep. 25, 2014

(51) Int. Cl. A63F 13/24

(52) U.S. Cl. CPC A63F 13/24

(57) ABSTRACT

A joystick, or video game controller, comprising a plurality of a plurality of piezoelectric depressible buttons and/or thermoelectric generators for powering the joystick. Piezoelectric components are disposed beneath depressible buttons and a plurality of directional keypads on the video game controller in some embodiments. The controller, in some embodiments, has a housing comprising an upper housing and lower housing, knob, buttons and triggers. The controller is configured for manual manipulation, while the underside of the base is configured to contact and be supported by the depressible buttons of the keypad. The controller may comprise one or more linear electric generators.

### BACKGROUND OF THE INVENTION

1. Field of the Invention

This invention relates to construction joysticks, and more particularly relates to wireless video game controllers.

2. Description of the Related Art

As computer clock speeds and 3D graphic rendering software have evolved, video games have become a standard form of entertainment in American homes and across the world. Joystick controllers, or game controllers, are used in various applications, from military to industrial, to control the movement of actual and virtual figures, vehicles and/or objects in video games. Such video games are generally used in a home environment, with a television interfaced to an external control box, such as an Xbox 360®, a Nintendo Wii, or the like. With recent advances in the art, these joystick controllers have become wireless, comprising transceivers, and function by broadcasting short-range radio signals to the control box on one or more frequencies.

Typically, joystick controllers constitute a bulbous hand-held electromechanical device with a plurality of depressible buttons, pads and sticks for directional control of the virtual objects depicted by the control box on the television. Virtual action movements of the objects are controlled with the depressible buttons, including actions such as fire, run, jump, etc. The great commercial success of home video games has spawned a growing secondary market for modified game controllers. Much of the design work in this field has been focused upon making the controllers more ergonomic and more easily used by the video game enthusiast of any age.

Joystick controllers have progressed to include not just thumbsticks and buttons, but also triggers, vibrators, ergonomic grips, and even LCD displays. As wireless joystick controllers have proliferated, so too have problems with battery packs powering the wireless joystick controllers going dead.

Current methods and apparatii do not readily facilitate a quick method for repowering the joystick controllers as they die. It is therefore desirable that a tool or mechanism be provided which can quickly repower the joystick controller.

### SUMMARY OF THE INVENTION

From the foregoing discussion, it should be apparent that a need exists for a joystick controller which can repower itself. Beneficially, such an apparatus would overcome many of the difficulties with prior art by providing a means for powering itself from the heat, light, pressure and/or movements of the fingers.

The present invention has been developed in response to the present state of the art, and in particular, in response to the problems and needs in the art that have not yet been fully solved by currently available apparatii and methods. Accordingly, the present invention has been developed to provide a wireless piezoelectric controller having one or more handgrip(s), the controller comprising: a housing defining a hollow recessed interior; a plurality of depressible buttons surrounded by a housing; one or more thumbstick controller(s); one or more thumbpad controller(s); one or more piezoelectric plates disposed beneath one or more of the plurality of buttons; and one or more thermoelectric generator(s) disposed within the housing within the handgrip(s).

The controller may further comprise one or more micro-electric generator(s) disposed within the hollow recess. The controller may also further comprise one or more one or more piezoelectric plates disposed beneath one or more of a thumbstick and a thumbpad.

In some embodiments, the controller may also further comprise one or more one or more piezoelectric plates disposed beneath one or more triggers. The micro electric generator may comprise an accumulator in some embodiments.

Electricity generated by the piezoelectric plate(s) and the thermoelectric generator(s) may charge a battery pack. The battery pack output may be between 0.1 and 3 volts. The battery pack may be detachable. In some embodiments, the controller further comprises one more photovoltaic cells affixed to the housing for generating electromotive force.

The controller may be designed as one of a digital guitar, skateboard, microphone, drums, and keypad. The controller, in alternate embodiments, further comprises one more linear electric generator(s) affixed to one of the baseplate and housing. The one or more handgrip(s) may comprise flexible surface material overlaying piezoelectric plates activating by a grip of the user.

A piezoelectric video game controller is also recited having one or more handgrip(s), the controller comprising: a housing defining a hollow recessed interior; a plurality of depressible buttons surrounded by a housing; one or more piezoelectric plates disposed beneath one or more of the plurality of buttons; and one or more micro-electric generator(s) disposed within the hollow recess.

This piezoelectric controller may further comprise one or more thermoelectric generator(s) disposed within the housing within the handgrip(s).

In some embodiments, the controller further comprises one more photovoltaic cells. In other embodiments, the controller further comprises one more linear electric generator(s) affixed to one of the baseplate and housing.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an upper perspective view of a traditional joystick controller;

FIG. 1B is an upper perspective view of a baseplate of traditional joystick controller;

FIG. 1C is an upper perspective view of a lower housing of traditional joystick controller;

FIG. 2A is an upper perspective view of the baseplate of a piezoelectric joystick controller in accordance with the present invention;

FIG. 2B is an upper perspective view of the upper housing of a piezoelectric joystick controller in accordance with the present invention;

FIG. 3 is a forward perspective view of a joystick controller in accordance with the present invention;

FIG. 4 is an upper perspective view of a joystick controller is accordance with the present invention; and

FIG. 5 is an upper perspective view of the baseplate of a piezoelectric joystick controller in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

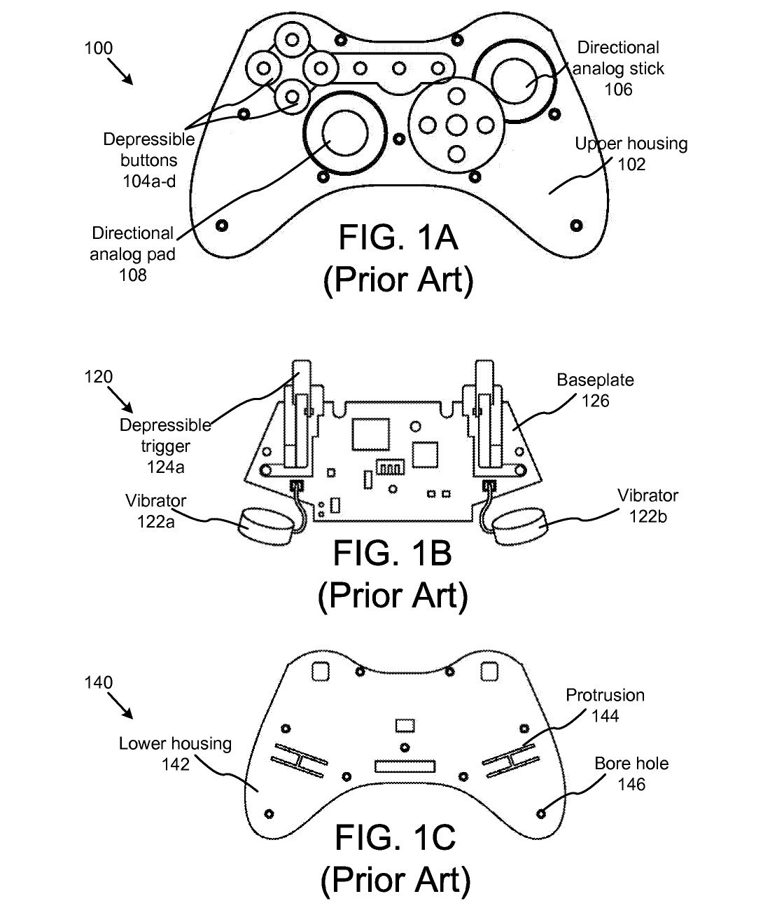

FIG. 1A is an upper perspective view of a traditional joystick controller 100. The joystick 100 comprises an upper housing 102, depressible buttons 104a-d, directional analog stick 106.

The depressible button 104a-d are well known to those of skill in the art, and comprise a biases switch for controlling some aspect of the video game. The buttons 104a-d are the physical user interface mechanism for signaling the control box interfacing with a television.

The baseplate 126 comprises a plate, circuit board, or the like for supporting the mechanical, electrical and electromechanical components of the controller. The baseplate 126 is affixed between an upper and lower housing.

FIG. 1B is an upper perspective view of a baseplate of traditional joystick controller 120. The joystick 120 comprises a vibrator 122a, a vibrator 122b, a depressible trigger 124a, and a baseplate 126.

The baseplate 126 comprises a circuit board or polymeric non-conducting planar insert for securing the various components of the controller 120. In some variations of the prior art, the controller 120 comprises vibrators 122 (i.e. rumble packs) for imparting motion controlled by the control box to a user's hands in response to certain virtual events in the video game.

The trigger 124 is activated by a user's index finger and disposed on the forward portion of the controller 120.

FIG. 1C is an upper perspective view of a lower housing of traditional joystick controller 140. The joystick 140 comprises a lower housing 142 defining a bore hole 146, and a protrusion 144.

The lower housing 142 and the upper housing 120 detachably affix to one another to define a hollow interior recess which houses the baseplate 126.

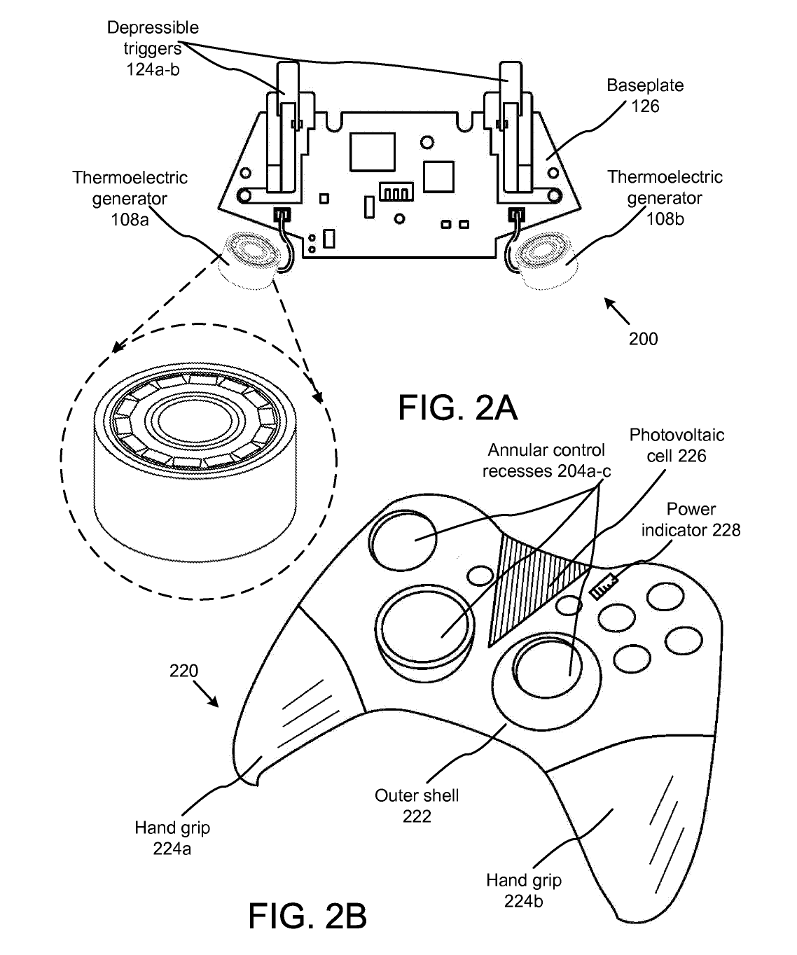

FIG. 2A is an upper perspective view of the baseplate of a piezoelectric joystick controller 200 in accordance with the present invention. The joystick controller 200 comprises depressible triggers 124a-b, a baseplate 126, and thermoelectric generators 108a-b.

The triggers 124a-b comprise a form of depressible button 104 affixed to the forward portion of the controller 200.

The thermoelectric generators 108a-d are known in the art. The generators 108a-d comprise devices which convert heat (temperature differences) directly into electrical energy, using the Seebeck effect or thermoelectric effect. The generators 108a-d may comprise bimetallic junctions, bismuth telluride (Bi₂Te₃), and/or lead telluride (PbTe) semiconductor p-n junctions. In some embodiments, the generators 108a-d comprise radioisotope thermoelectric generators.

The generators 108a-d are positioned within the handgrip(s) portion of the upper housing 102. As a user plays a video game, the controller 200 heats up from the user's body heat transferred through the hands to controller 200. In those embodiments, the grip portion of the outer housing 102 may be fabricated from a metal, alloy or other material with relatively high thermal conductivity.

In some embodiments, the controller 200 comprises microturbines in place of, or in addition to, the thermoelectric generators 108a-b. The thermoelectric generators 108a-b may comprise TAPECs (Thermo Acoustic Piezo Energy Conversion).

FIG. 2B is an upper perspective view of the upper housing of a piezoelectric joystick controller 220 in accordance with the present invention. The joystick controller 220 comprises handgrips 224a-b, annular control recesses 204a-c, an outer shell 222, a photovoltaic cell 226, and a power indicator 228.

The upper housing 102 defines annular control recesses 204a-c. Thumbsticks 106, thumbpads 108 and buttons 104 rise orthogonally from the baseplate 126 through the annular control recesses 204a-c.

The controller 220 comprises a power indicator 226 which display the stored power of the battery pack detachably affixed to the controller 220. The power indicator 226 is an LCD display.

The handgrips 224a-b protrude from the controller 220 for gripping by a user. In some embodiments, the controller 220 consists of a single handgrip 224.

The controller 220 also comprises a photovoltaic cell 226. In various embodiments of the present invention, the controller 220 generates electricity from light using one or more photovoltaic cells 226 affixed or disposed upon the outer housing 102. In some embodiments, the outer housing 102 defines recesses for housing photovoltaic cells 226 which are flush with the convex outer surface of the outer housing 102.

In various embodiments of the present invention, the outer housing 102 may entirely consist of a photovoltaic cell 226.

The photovoltaic cell 226 may be fabricated of monocrystalline silicone, polycrystalline silicone, ribbon silicone, cadmium telleride, copper indium gallium selenide, gallium arsenide, ruthenium metalorganic dye, polyphenylene vinylene, or other materials known to those of skill in the art.

The controller 220 may comprise a touchscreen for being engaged by the finger tips of a user. The touchscreen surface may be fabricated of piezoelectric material. Piezoelectric material may underlie the touchscreen which is activated by pressure against the touchscreen.

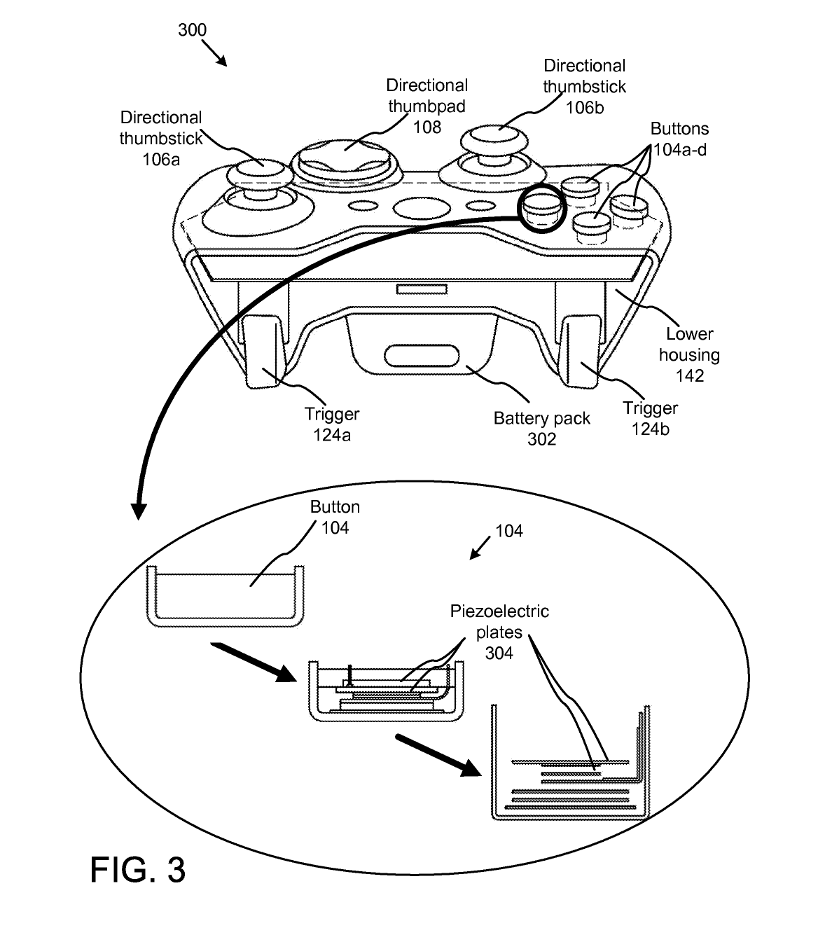

FIG. 3 is a forward perspective view of a joystick controller 300 in accordance with the present invention. The joystick 300 comprises depressible buttons 104a-d, a lower housing 142, triggers 124a-b, directional thumbsicks 106a-b, a directional thumbpad 108, and a battery pack 302. The button 104 comprises piezoelectric plates 304.

The piezoelectric plates 304 generate electricity when flexed. The plates 304 may comprise one a variety of solid materials known in the art, including crystals such as lead zirconate titanate, ceramics, and/or biological matter such as bone, DNA and various proteins. When the plates 304 are depressed, flexed, or otherwise stressed piezoelectricity is generated, which piezoelectricity is used to charge a battery pack affixed to the controller 300.

The buttons 104 comprises one or more piezoelectric plates 304 stacked one upon another under the main portion of the button 104 between the button 104 and the baseplate 126.

In various embodiments of the present invention, the controller 300 comprises a detachable or permanently affixed battery pack 302.

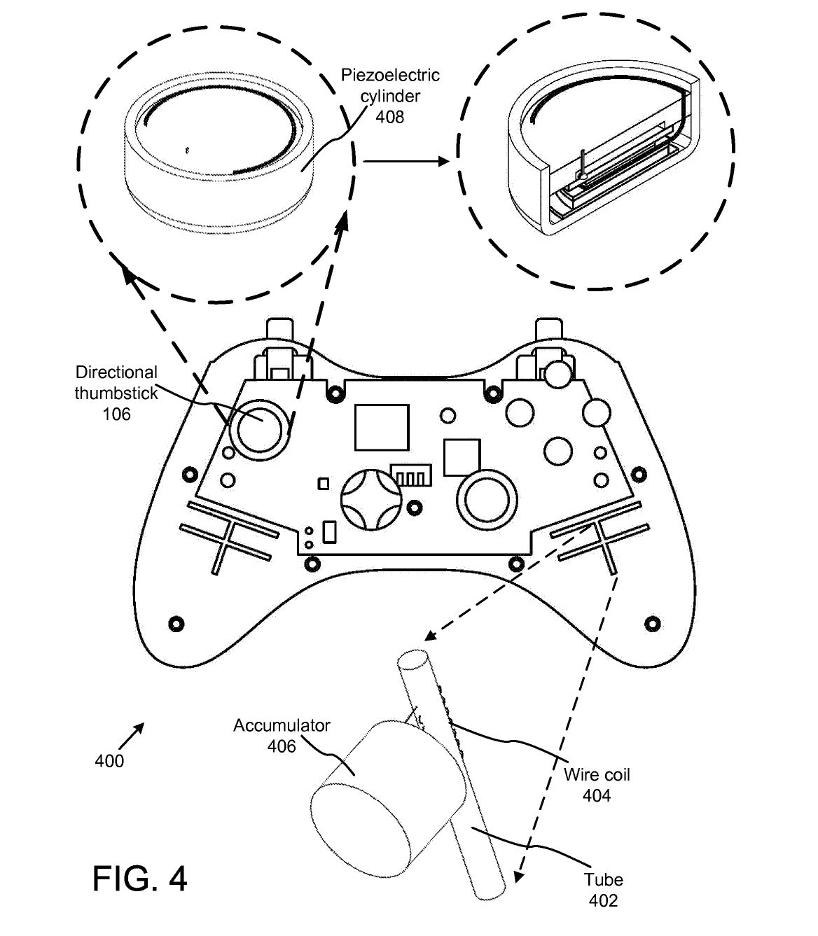

FIG. 4 is an upper perspective view of a joystick controller 400 is accordance with the present invention. The joystick 400 comprises a directional thumbstick 106, a piezoelectric cylinder 408, a tube 402, a wire coil 404, and an accumulator 406.

Like the buttons 104, the thumbsticks 106 and thumbpads 108 may overlay piezoelectric plates 304 and may generate electricity from pressure and movement applied to the piezoelectric plates 304.

In various embodiments of the present invention, the baseplate 126 comprises one or more tubes 402 surrounded by coiled wire 404. A magnet slides back and forth within the tube as a user moves the controller 400 about inducing a current through the coiled wire 404 and charging an accumulator 406. Through this mechanism, the controller 400 converts kinetic energy from the user's hand using electromagnetic induction to power the controller 400. The coiled wire 404, tube 402, magnet and accumulator 406 together comprise a linear electric generator.

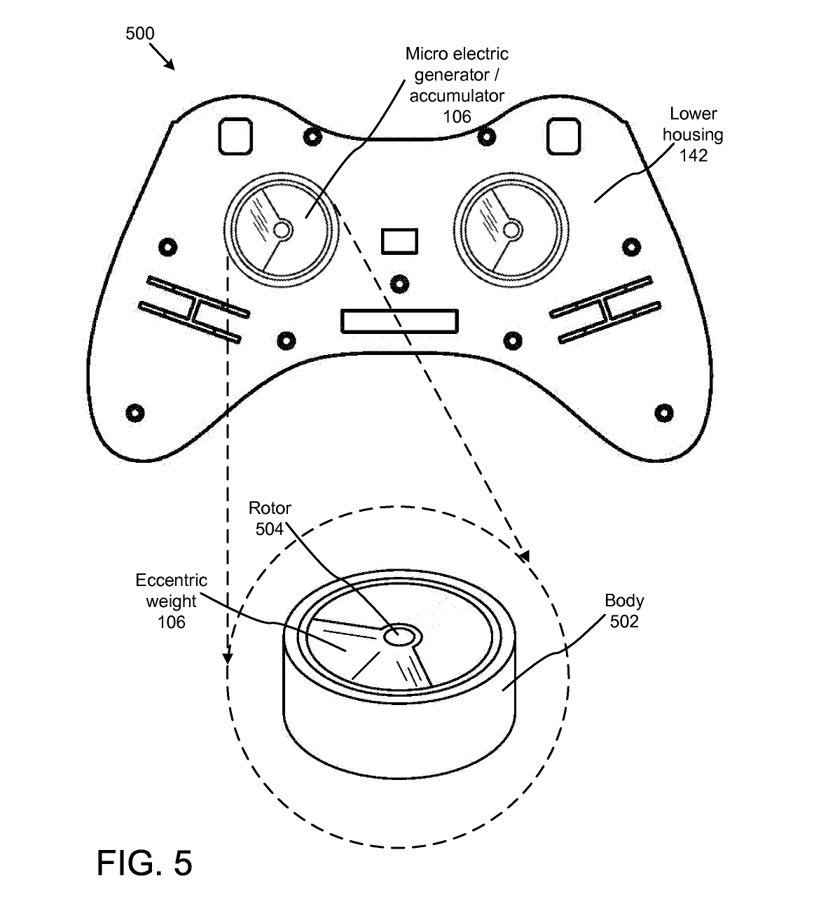

FIG. 5 is an upper perspective view of the baseplate of a piezoelectric joystick controller 500 in accordance with the present invention. The joystick controller 500 comprises a micro-electric generator 106, a lower housing 142, an eccentric weight 106, a body 502, and a rotor 504.

The lower housing 142 comprises a concave shell fabricated of polymeric materials.

The lower housing 142 in the shown embodiment is affixed to two micro-electric generators 106. In various embodiments, these micro-electric generators 106 comprise one or more eccentric weights 106 rotating axially around a rotor 504. The rotor 504 spins within the micro-electric generator 106. The micro-electric generator 106, via the spinning eccentric weights 106, convert the mechanical energy of the motion of the user's hand into electrical energy.

In some embodiments of the present invention, one or more of the micro-electric generators 106 are affixed to the baseplate 126 and/or the upper housing 102.

In various embodiments of the present invention, the joystick controller comprises a control box accessory such as a digital guitar, skateboard, microphone, drums, keypad, headset or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wireless piezoelectric controller having one or more handgrip(s), the controller comprising:
a housing defining a hollow recessed interior;
a plurality of depressible buttons surrounded by a housing;
one or more thumbstick controller(s);
one or more thumbpad controller(s);
one or more piezoelectric plates disposed beneath one or more of the plurality of buttons; and
one or more thermoelectric generator(s) disposed within the housing within the handgrip(s).

2. The controller of claim 1, further comprising one or more micro-electric generator(s) disposed within the hollow recess.

3. The controller of claim 1, further comprising one or more one or more piezoelectric plates disposed beneath one or more of a thumbstick and a thumbpad.

4. The controller of claim 1, further comprising one or more one or more piezoelectric plates disposed beneath one or more triggers.

5. The controller of claim 1, wherein the micro electric generator comprises an accumulator.

6. The controller of claim 1, wherein electricity generated by the piezoelectric plate(s) and the thermoelectric generator(s) charge a battery pack.

7. The controller of claim 6, wherein the battery pack output is between 0.1 and 3 volts.

8. The controller of claim 6, wherein the battery pack is detachable.

9. The controller of claim 1, further comprising one more photovoltaic cells affixed to the housing for generating electromotive force.

10. The controller of claim 1, wherein the joystick controller is designed as one of a digital guitar, skateboard, microphone, drums, and keypad.

11. The controller of claim 1, further comprising one more linear electric generator(s) affixed to one of the baseplate and housing.

12. The controller of claim 1, wherein the one or more handgrip(s) comprise flexible surface material overlaying piezoelectric plates activating by a grip of the user.

13. A piezoelectric video game controller having one or more handgrip(s), the controller comprising:
a housing defining a hollow recessed interior;
a plurality of depressible buttons surrounded by a housing;
one or more piezoelectric plates disposed beneath one or more of the plurality of buttons; and
one or more micro-electric generator(s) disposed within the hollow recess.

14. The piezoelectric controller of claim 13, further comprising one or more thermoelectric generator(s) disposed within the housing within the handgrip(s).

15. The controller of claim 13, further comprising one more photovoltaic cells.

16. The controller of claim 13, further comprising one more linear electric generator(s) affixed to one of the baseplate and housing.
